(19) United States
(12) Patent Application Publication
(10) Pub. No.: US 2010/0042934 A1
(43) Pub. Date: Feb. 18, 2010

(54) PSEUDO TAKING-OUT OPERATION METHOD AND PROGRAMS THEREFOR

(76) Inventors: Kouji Ohura, Shibuya-ku (JP); Takayuki Matsuzawa, Shibuya-ku (JP); Hirochika Matsuo, Shibuya-ku (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/521,800

(22) PCT Filed: Dec. 27, 2007
(86) PCT No.: PCT/JP2007/001483

§ 371 Date: Jun. 30, 2009

(30) Foreign Application Priority Data
Jan. 5, 2007 (JP) 2007-000809

(51) Int. Cl. G06F 3/048

(52) U.S. Cl. 715/760

(57) ABSTRACT

A computer-implemented method for displaying a pseudo taking-out operation of an object from a predetermined area out of the predetermined area is disclosed. The predetermined area is an area defined within a window of a web browser to display a particular content. The particular content is displayed by playing a predetermined file using a particular plug-in of the web browser. The object is at least one part of the particular content. The method comprises: obtaining an identification of the object from the predetermined file; obtaining a data file from a network in accordance with the identification, the data file providing an alternative object, the alternative object having an appearance corresponding to the object; and displaying the alternative object at a position of the object.

### TECHNICAL FIELD

This invention relates to a computer-implemented method for displaying a pseudo taking-out operation of an object from a predetermined area of a window of a web browser such as an Internet Explorer® out of the web browser's window on a desktop of a computer system, and to a computer program product therefor.

### BACKGROUND ART

The recent web browsers have functions extended by means of various plug-ins therefor, such as a Flash Player®, and are enabled to express more visual contents other than contents consisting of texts and still images. For more information about Flash Player®, see http://www.adobe.com/jp/products/flashplayer/

Using the Flash® technology, Flash®-based “gadgets” and a gadget platform therefor have also been developed. The gadget platform for Flash®-based gadgets is called “GIZMO.” For more information about “GIZMO”, see http://gizmo.anthilljp/ or http://gizmo.anthill.jp/en/ and “GIZMO Programmer's Bible” by Tanaka et. al., Mainichi Communications, November 2006.

### DISCLOSURE OF THE INVENTION

It is an object of the present invention to provide a new visual expression by using a plug-in of a web browser.

According to one aspect of the present invention, a computer-implemented method is provided for displaying a pseudo taking-out operation of an object from a predetermined area out of the predetermined area. The predetermined area is an area defined within a window of a web browser to display a particular content. The particular content is displayed by playing a predetermined file using a particular plug-in of the web browser. The object is at least one part of the particular content. The method comprises: obtaining an identification of the object from the predetermined file; obtaining a data file from a network in accordance with the identification, the data file providing an alternative object, the alternative object having an appearance corresponding to the object; and displaying the alternative object at a position of the object.

According to another aspect of the present invention, a computer program product embodied on a computer readable medium is provided for displaying a pseudo taking-out operation of an object from a predetermined area out of the predetermined area. The predetermined area is an area defined within a window of a web browser to display a particular content. The particular content is displayed by playing a predetermined file using a particular plug-in of the web browser. The object is at least one part of the particular content. The computer program product comprises: computer code for obtaining an identification of the object from the predetermined file; computer code for obtaining a data file from a network in accordance with the identification, the data file providing an alternative object, the alternative object having an appearance corresponding to the object; and computer code for displaying the alternative object at a position of the object.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a block diagram schematically showing a typical computer system in accordance with an embodiment of the present invention;

FIG. 2 is a diagram schematically showing a computer-implemented method for displaying a pseudo taking-out operation in accordance with an embodiment of the present invention.

FIG. 3 is a flowchart schematically showing a process of displaying an alternative object according to an embodiment of the present invention.

FIG. 4 is a diagram schematically showing a visual-effect expression according to an embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### BEST MODE FOR CARRYING OUT THE INVENTION

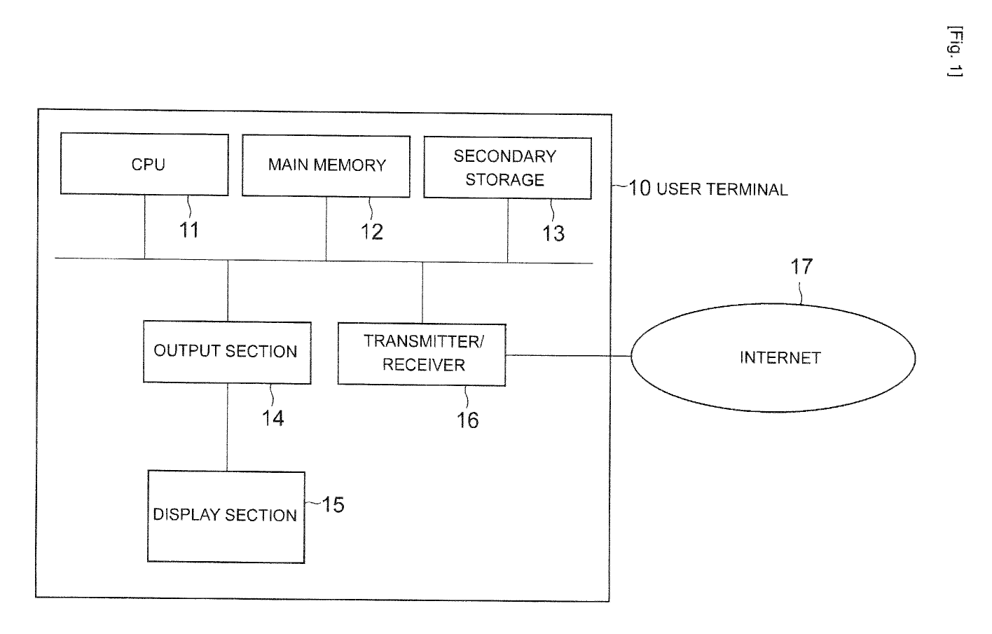

With reference to FIG. 1, a user terminal 10 comprises a CPU 11, a main memory 12, a secondary storage 13, an output section 14, and a transmitter/receiver 16 which are connected to each other via a bus. The user terminal 10 also comprises a display section 15 connected to the output section 14. The main memory 12 comprises, for example, a dynamic access random memory (DRAM). The secondary storage 13 comprises, for example, a hard disk drive (HDD). The display section 15 comprises a display unit such as a liquid crystal display (LCD) unit or the like.

Programs according to an embodiment of the present invention are stored in the secondary storage 13. The programs are loaded on the main memory 12 and are executed by the CPU 11. The main memory 12 also stores, but temporarily, data generated during the operation of the CPU 11 or data to be used by the CPU 11.

The transmitter/receiver 16 establishes a connection between the user terminal 10 and the Internet 17 under the control of the CPU 11. As a result of the prescribed process, an image and so on is displayed on the display section 15 via the output section 14.

The programs according to the present embodiment are read and executed by the CPU 11. As the result, the following operations will be carried out.

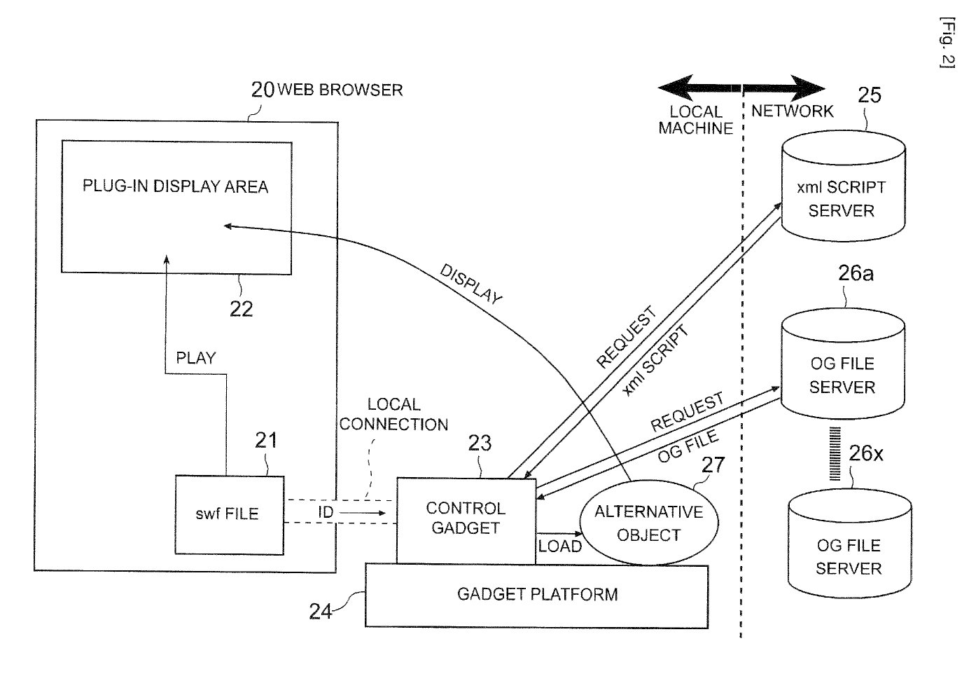

With reference to FIG. 2, a web browser 20 is displayed on the display section 15. The web browser 20 reads an html file which includes an URL of an swf file 21. Then the web browser 20 downloads the swf file 21 according to the statements included in the html file and displays the same on the web browser 20.

The swf file 21 is a file playable by a Flash Player®. When the swf file 21 is played by the Flash Player®, the played swf file 21 is displayed within a plug-in display area 22 of the web browser 20 to provide a user with a particular content. In this embodiment, the particular content includes an object that is expressed as being seemingly taken out of the particular content.

A control gadget 23 is an application program operative on a gadget platform 24 and is cooperable with the swf file 21 via a Local Connection. In this embodiment, the control gadget 23 provides a pseudo taking-out operation of the above-mentioned object from the plug-in display area 22 out of the plug-in display area 22 or out of the web browser 20. The control gadget 23 of the present embodiment is visually-transparent because there is no need to be visible from the user. However, the control gadget 23 may be visible or may be included in a visible gadget.

An xml script server 25 in this embodiment stores a plurality of xml script files and a plurality of identifications so that the xml script files are associated with the identifications, respectively. Each of the xml script files of the present embodiment includes statements for an URL of an entity file indicated by the associated identification, like a wvx file or an asx file.

Each object gadget (OG) server 26a-26x stores an object gadget (OG) file for providing an alternative object 27. The object gadget is a gadget different from the control gadget 23 but operative on the gadget platform 24. The alternative object 27 has an appearance corresponding to the above-mentioned object displayed within the plug-in display area 22. As explained hereinabove, the alternative object 27 of the present embodiment is implemented as the object gadget operative on the gadget platform 24, but the present invention is not limited thereto.

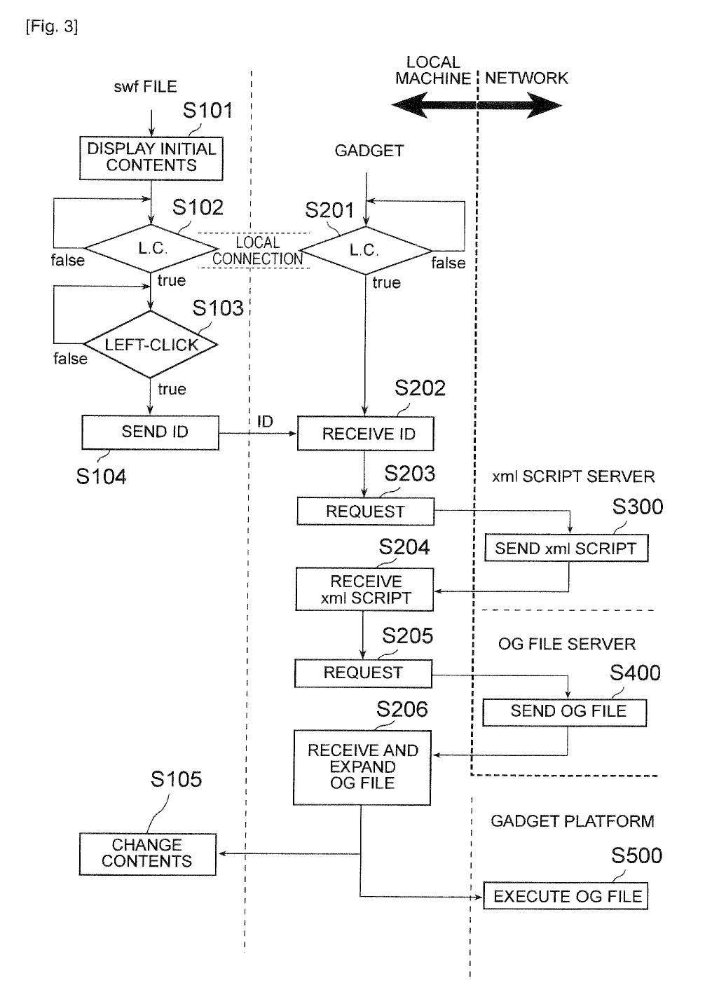

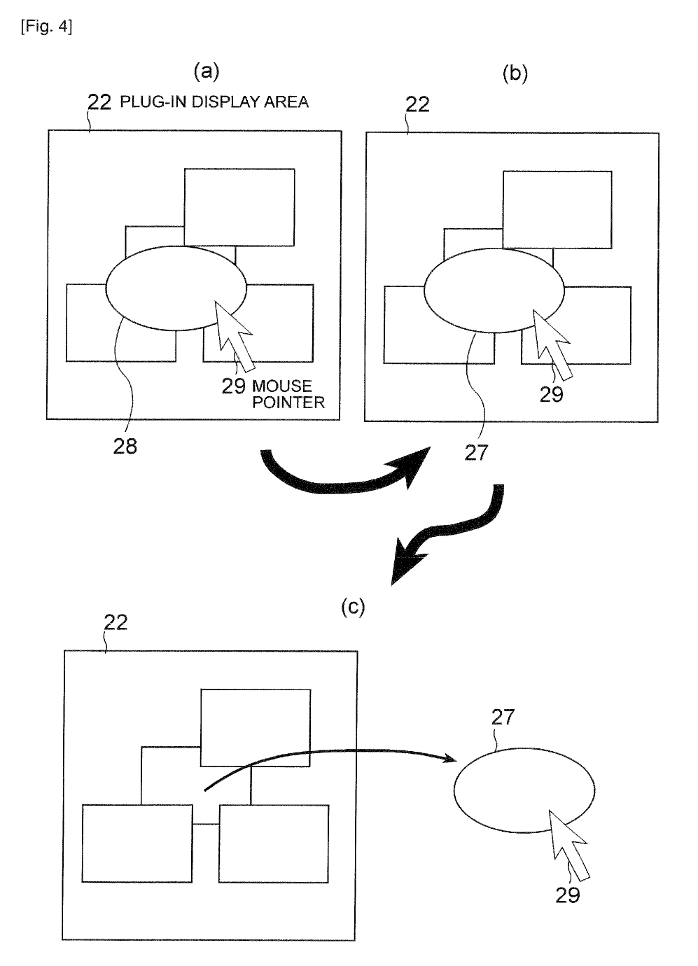

With reference to FIG. 3 as well as FIG. 4, next explanation will be made about operations based on a communication between the played swf file 21 and the control gadget 23.

When started up, the control gadget 23 searches a partner for a Local Connection (S201).

When the swf file 21 is played by the Flash player®, the played swf file 21 provides an initial content displayed within the plug-in display area 22 of the web browser 20 (S101). Note here that the initial content of this example includes an object 28 as shown in (a) in FIG. 4. Then the swf file 21 searches a partner for the Local Connection (S102).

The Local Connection is established when the swf file 21 and the control gadget 23 recognize each other as connection partners.

When the object 28 is left-clicked ((a) in FIG. 4), the swf file 21 detects the left-click event (S103) and sends the identification of the clicked object 28 to the control gadget 23 (S104) via the Local Connection so that handling processes of mouse events are transferred from the swf file 21 to the control gadget 23 or the gadget platform 24. In this connection, the control gadget 23 or the gadget platform 24 obtains a position information such as coordinates of a mouse pointer 29. In other words, the control gadget 23 can acknowledge where the mouse pointer 29 is upon the object 28 is left-clicked.

Upon receiving the identification from the swf file 21 (S202), the control gadget 23 sends a request to the xml script server 25 (S203) by the use of the identification to obtain an xml script associated with the identification. In this embodiment, the control gadget 23 sends the received identification as the request to the xml script server 25 without any processing to the received identification.

Upon receiving the identification from the control gadget 23, the xml script server 25 selects the xml script associated with the received identification and sends the selected xml script to the control gadget 23 (S300).

Upon receiving the xml script from the xml script server 25 (S204), the control gadget 23 interprets the received xml script to obtain a URL stated in the received xml script and sends a request to the OG file server 26a in accordance with the obtained URL to obtain a file of the object gadget that corresponds to the alternative object 27 (S205).

In response to the request from the control gadget 23, the object file server 26a sends the object gadget file corresponding to the request to the control gadget 23 (S400).

The control gadget 23 expands the received object gadget file to a temporary folder (not shown) (S206) and executes the expanded object gadget file on the gadget platform 24 (S500) so as to display the alternative object 27. As shown in (b) in FIG. 4, the alternative object 27 in this embodiment is displayed at the position of the mouse pointer 29. In other words, the alternative object 27 is displayed at the position where the object 28 was displayed.

Upon the execution of the object gadget file, the swf file 21 of this embodiment changes the contents displayed in the plug-in display area 22 so that the object 28 is eliminated or erased from the initial content.

In the example illustrated in (b) in FIG. 4, simultaneously with the erasing of the object 28, the alternative object 27 is displayed at the position where the object 28 was displayed so that it looks like the displayed contents have not been changed from the initial contents. However, the alternative object 27 is a program which operates on the gadget platform 24, and the display area thereof is not limited to an area within the window of the web browser 20. Therefore, as shown in (c) in FIG. 4, the object 28 displayed in the plug-in display area 22 looks as if taken out of the web browser 20.

Although the alternative object 27 has the same size and the same shape as the object 28 in the example illustrated in FIG. 4, the present invention is not limited thereto. The alternative object 27 may have a size different from the object 28. For example, the alternative object 27 may be larger than the object 28. In addition, the alternative object 27 may have a shape just different from the object 28. In this connection, the sentence “the alternative object 27 has an appearance corresponding to the object 28” means that the alternative object 27 has a correlation to the object 28.

The present application is based on Japanese patent applications of JP2007-000809 filed before the Japan Patent Office on Jan. 5, 2007, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

1. A computer-implemented method for displaying a pseudo taking-out operation of an object from a predetermined area out of the predetermined area, the predetermined area being an area defined within a window of a web browser to display a particular content, the particular content being displayed by playing a predetermined file using a particular plug-in of the web browser, the object being at least one part of the particular content, the method comprising:
obtaining an identification of the object from the predetermined file;
obtaining a data file from a network in accordance with the identification, the data file providing an alternative object, the alternative object having an appearance corresponding to the object; and
displaying the alternative object at a position of the object.

2. The method according to claim 1 further comprising:
erasing the object displayed in the predetermined area before the alternative object is displayed.

3. The method according to claim 1, wherein the obtaining of the data file comprising:
obtaining an xml script from a first server in accordance with the identification, the xml script including a specific URL; and
obtaining the data file from a second server in accordance with the specific URL, the second server being different from the first server.

4. The method according to claim 1, wherein the particular plug-in is a Flash Player® and the predetermined file is an swf file.

5. The method according to claim 1, wherein the data file is operative as a gadget on a particular gadget platform preliminarily installed in a local machine.

6. The method according to claim 1, further comprising:
establishing a Local Connection with the predetermined file to obtain the identification from the predetermined file via the Local Connection.

7. The method according to claim 1, wherein:
the obtaining of the identification is carried out upon the object is left-clicked; and
the displaying of the alternative object is carried out so that the alternative object is displayed at a position of a mouse pointer.

8. A computer program product embodied on a computer readable medium for displaying a pseudo taking-out operation of an object from a predetermined area out of the predetermined area, the predetermined area being an area defined within a window of a web browser to display a particular content, the particular content being displayed by playing a predetermined file using a particular plug-in of the web browser, the object being at least one part of the particular content, the computer program product comprising:
computer code for obtaining an identification of the object from the predetermined file;
computer code for obtaining a data file from a network in accordance with the identification, the data file providing an alternative object, the alternative object having an appearance corresponding to the object; and
computer code for displaying the alternative object at a position of the object.

9. The computer program product according to claim 8, further comprising computer code for erasing the object displayed in the predetermined area before the alternative object is displayed.

10. The computer program product according to claim 8, wherein the computer code for obtaining a data file comprises:
computer code for obtaining an xml script from a first server in accordance with the identification, the xml script including a specific URL; and
computer code for obtaining the data file from a second server in accordance with the specific URL, the second server being different from the first server.

11. The program according to claim 8, wherein the particular plug-in is a Flash Player® and the predetermined file is an swf file.

12. The computer program product according to claim 8, the computer program product functioning as a control gadget on a particular gadget platform preliminarily installed in a local machine.

13. The computer program product according to claim 12, wherein the data file is operative as another gadget on a particular gadget platform.

14. The computer program product according to claim 8, further comprising:
computer code for establishing a Local Connection with the predetermined file to obtain the identification from the predetermined file via the Local Connection.

15. The computer program product according to claim 8, wherein:
the computer code for obtaining an identification is executed upon the object is left-clicked; and
the computer code for displaying the alternative object is executed so that the alternative object is displayed at a position of a mouse pointer.
